(19) United States
(12) Patent Application Publication
(10) Pub. No.: US 2018/0059724 A1
(43) Pub. Date: Mar. 1, 2018

(54) TABLET PROTECTIVE COVER AND ELECTRONIC DEVICE

(71) Applicant: PEGATRON CORPORATION, Taipei City (TW)

(72) Inventors: Hung-Yun WU, Taipei City (TW); Shyh-Heh HWANG, Taipei City (TW); Ho-Ching HUANG, Taipei City (TW); Hui-Chen WANG, Taipei City (TW); I-Tien HSIEH, Taipei City (TW)

(21) Appl. No.: 15/602,766

(22) Filed: May 23, 2017

(30) Foreign Application Priority Data
Aug. 26, 2016 (TW) 105127571

(51) Int. Cl. G06F 1/16

(52) U.S. Cl. CPC G06F 1/1632; G06F 1/1681; G06F 1/1679; G06F 1/1626

(57) ABSTRACT

A tablet protective cover and electronic device using the same is applied for connecting the tablet to a dock for expanding the tablet. The tablet protective cover includes a bearing seat, a back cover and a hook. The bearing seat is located on a hinge of the dock. A first end of the back cover is connected to the bearing seat, so that the back cover can rotate relative to the dock. The tablet can be placed on the bearing seat and electrically connected to the dock, and the back cover covers the back of the tablet. The hook is located on a second end of the back cover away from the bearing seat for fixing the tablet on the bearing seat.

### CROSS REFERENCE TO RELATED APPLICATIONS

This Non-provisional application claims priority under 35 U.S.C. § 119(a) on Patent Application No(s). 105127571 filed in Taiwan, Republic of China on Aug. 26, 2016, the entire contents of which are hereby incorporated by reference.

### BACKGROUND

### Technology Field

The present disclosure relates to a tablet protective cover and, in particular, to a tablet protective cover capable of fixing the table by the back cover and a hook disposed on the back cover.

### Description of Related Art

The conventional dock generally provides a bearing seat for receiving the tablet, so the weight and force of the tablet are focused on the hook inside the bearing seat. Besides, the bearing seat further includes a release member for moving the hook to release the tablet. The sizes of the hook and the release member are limited to the dimension of the bearing seat. When the size of the tablet is large, the above mechanism for fixing the bottom of the tablet only may not strong enough.

Therefore, it is desired to provide a tablet protective cover having a curved back cover and a hook disposed on the back cover.

### SUMMARY

The present disclosure provides a tablet protective cover and an electronic device that can solve the problems of unfirmly installation and focusing force at one point, which are caused by the connection mechanism of the conventional tablet and dock with the hook in the bearing seat only.

In order to achieve the above, the present disclosure discloses a tablet protective cover for connecting a tablet to a dock for expanding the tablet. The tablet protective cover includes a bearing seat, a back cover, and a hook. The bearing seat is located on a hinge of the dock. A first end of the back cover is connected to the bearing seat, so that the back cover is capable of rotating relative to the dock. The tablet is placed on the bearing seat and electrically connected to the dock, and the back cover covers the back of the tablet. The hook is located on a second end of the back cover away from the bearing seat for fixing the tablet on the bearing seat.

In one embodiment, each of the second end, a third end and a fourth end of the back cover has a curved structure for fixing the tablet, and the third end and the fourth end are substantially perpendicular to the first end.

In one embodiment, each of the third end and the fourth end of the back cover has a curved structure for fixing the tablet.

In one embodiment, the hook is rotated or shifted for fixing the tablet.

In one embodiment, the back cover is made of metal or plastic material.

In addition, the disclosure also discloses an electronic device for connecting to a tablet. The electronic device includes a dock and a tablet protective cover. The tablet protective cover includes a bearing seat, a back cover and a hook. The bearing seat is located on a hinge of the dock. A first end of the back cover is connected to the bearing seat, so that the back cover is capable of rotating relative to the dock. The tablet is placed on the bearing seat and electrically connected to the dock, and the back cover covers the back of the tablet. The hook is located on a second end of the back cover away from the bearing seat for fixing the tablet on the bearing seat.

In one embodiment, each of the second end, a third end and a fourth end of the back cover has a curved structure for fixing the tablet, and the third end and the fourth end are substantially perpendicular to the first end.

In one embodiment, each of the third end and the fourth end of the back cover has a curved structure for fixing the tablet.

In one embodiment, the hook is rotated or shifted for fixing the tablet.

In one embodiment, the back cover is made of metal or plastic material.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing a tablet protective cover according to an embodiment of the disclosure;

FIG. 2 is a schematic diagram showing the tablet protective cover in operation according to a first embodiment of the disclosure;

FIG. 3 is a side view of the tablet protective cover according to the first embodiment of the disclosure;

FIG. 4 is a side view of the tablet protective cover according to a second embodiment of the disclosure;

FIG. 5 is a schematic diagram showing that the hook of the second embodiment is rotated to fasten the tablet; and

FIG. 6 is a schematic diagram showing that the hook of the second embodiment is shifted to fasten the tablet.

### DETAILED DESCRIPTION OF THE DISCLOSURE

The present disclosure will be apparent from the following detailed description, which proceeds with reference to the accompanying drawings, wherein the same references relate to the same elements.

In the following descriptions, the terms, such as “comprise”, “include”, “have”, “contain” and the likes, are limiting words and should be understood as “include and not limit to”.

In the following descriptions, the term “and/or” should be any or all combinations of the listed objects.

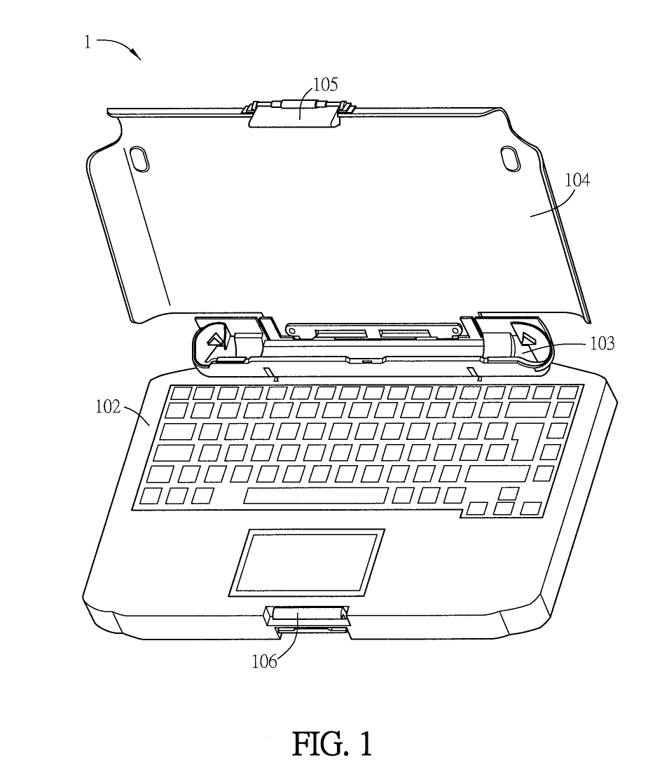

FIG. 1 is a schematic diagram showing a tablet protective cover 1 according to an embodiment of the disclosure. Referring to FIG. 1, the tablet protective cover 1 is applied to connecting a tablet to a dock 102 for expanding the tablet. The tablet protective cover 1 includes a bearing seat 103, a back cover 104, and a hook 105. The bearing seat 103 is located on a hinge of the dock 102. A first end of the back cover 104 is connected to the bearing seat 103, so that the back cover 104 can be rotated relative to the dock 102.

In practice, the tablet is placed on the bearing seat 103 and electrically connected to the dock 102, and the back cover 104 covers the back of the tablet. The hook 105 is located on a second end of the back cover 104 away from the bearing seat 103 for fixing the tablet on the bearing seat 102.

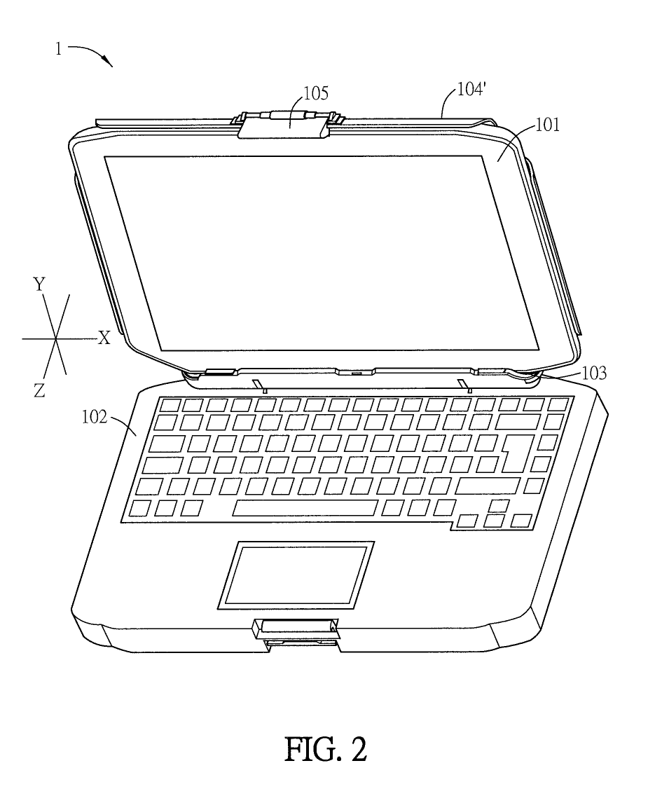

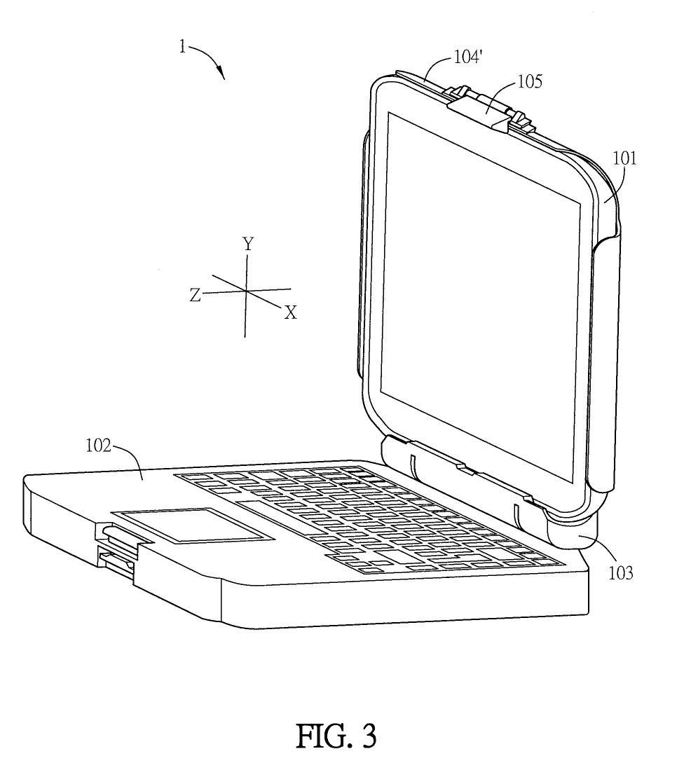

FIG. 2 is a schematic diagram showing the tablet protective cover 1 in operation according to a first embodiment of the disclosure, and FIG. 3 is a side view of the tablet protective cover 1 according to the first embodiment of the disclosure. In the tablet protective cover 1, as shown in FIGS. 2 and 3, each of the second end, a third end and a fourth end of the back cover 104′ has a curved structure for fixing the tablet 101. The second end is opposite to the first end and located away from the bearing seat 103, and the third end and the fourth end are substantially perpendicular to the first end. When assembling the tablet 101 and the dock 102, the tablet 101 is inserted into the bearing seat 103 along the-Z direction or the-Y direction.

The curved structures of the second, third and fourth ends of the back cover 104′ can restrict the movement of the tablet 101 on the display plane (XY plane), and the hook 105 and the bearing seat 103 can restrict the movement of the tablet 101 along the Z direction.

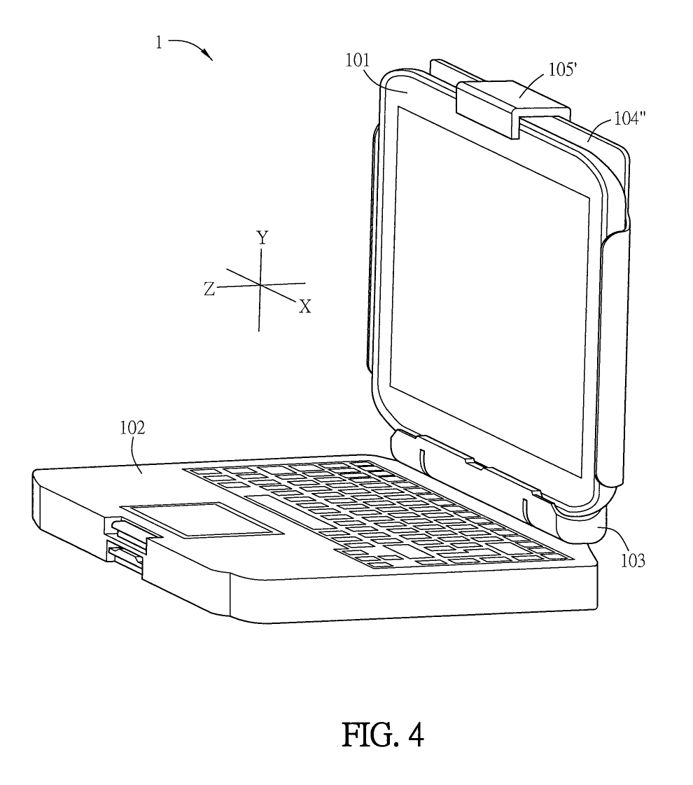

FIG. 4 is a side view of the tablet protective cover 1 according to a second embodiment of the disclosure. In the second embodiment, as shown in FIG. 4, each of the third end and the fourth end of the back cover 104″ has a curved structure for fixing the tablet 101. When assembling the tablet 101 and the dock 102, the tablet 101 is inserted into the bearing seat 103 along the-Z direction.

The curved structures of the third and fourth ends of the back cover 104″ can restrict the movement of the tablet 101 on the X direction of the display plane, the hook 105′ can restrict the movement of the tablet 101 along the Y direction, and the hook 105′ and the bearing seat 103 can restrict the movement of the tablet 101 along the Z direction.

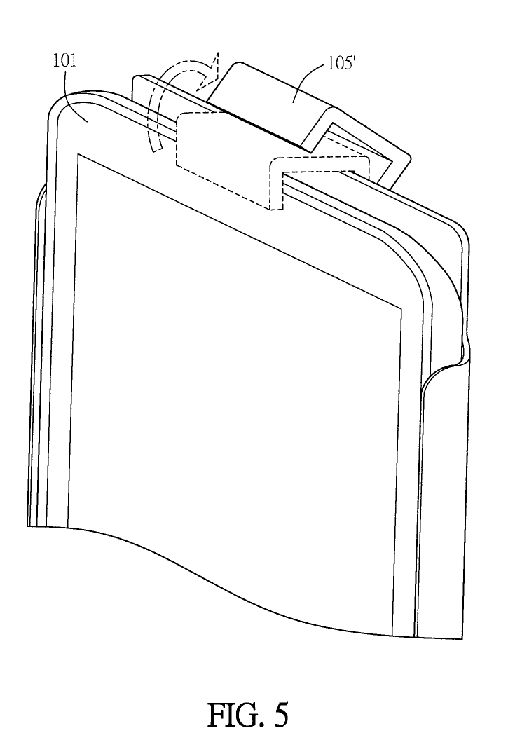

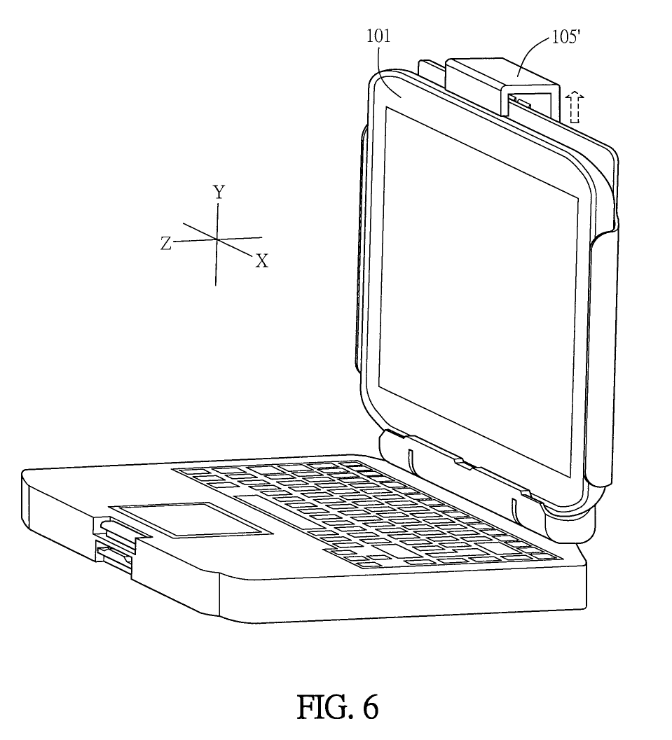

FIG. 5 is a schematic diagram showing that the hook 105′ of the second embodiment is rotated to fasten the tablet 101, and FIG. 6 is a schematic diagram showing that the hook 105′ of the second embodiment is shifted to fasten the tablet 101. In this embodiment, as shown in FIGS. 5 and 6, the hook 105′ is rotated (see FIG. 5) or shifted (see FIG. 6) for fixing the tablet 101.

In addition, the above-mentioned tablet protective cover can be applied to an electronic device for connecting to a tablet. The electronic device includes a dock for expanding the tablet and a tablet protective cover. The tablet protective cover includes a bearing seat, a back cover and a hook. Since the back cover and the hook disposed on the back cover can assist to firmly fix the tablet, the tablet protective cover of the disclosure can solve the problems of unfirmly installation and focusing force at the hook inside the bearing seat, which are caused by the connection mechanism of the conventional tablet and dock with the hook inside the bearing seat only.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A tablet protective cover for connecting a tablet to a dock for expanding functions of the tablet, the tablet protective cover comprising:
a bearing seat located on a hinge of the dock;
a back cover, wherein a first end of the back cover is connected to the bearing seat, so that the back cover is capable of rotating relative to the dock, the tablet is placed on the bearing seat and electrically connected to the dock, and the back cover covers a back of the tablet; and
a hook located on a second end of the back cover away from the bearing seat for fixing the tablet on the bearing seat.

2. The tablet protective cover of claim 1, wherein each of the second end, a third end and a fourth end of the back cover has a curved structure for fixing the tablet, and the third end and the fourth end are substantially perpendicular to the first end.

3. The tablet protective cover of claim 1, wherein each of a third end and a fourth end of the back cover has a curved structure for fixing the tablet, and the third end and the fourth end are substantially perpendicular to the first end.

4. The tablet protective cover of claim 2, wherein the hook is rotated or shifted for fixing the tablet.

5. The tablet protective cover of claim 3, wherein the hook is rotated or shifted for fixing the tablet.

6. The tablet protective cover of claim 1, wherein the back cover is made of metal or plastic material.

7. An electronic device for connecting to a tablet, comprising:
a dock for expanding the tablet;
a bearing seat located on a hinge of the dock;
a back cover, wherein a first end of the back cover is connected to the bearing seat, so that the back cover is capable of rotating relative to the dock, the tablet is placed on the bearing seat and electrically connected to the dock, and the back cover covers a back of the tablet; and
a hook located on a second end of the back cover away from the bearing seat for fixing the tablet on the bearing seat.

8. The electronic device of claim 7, wherein each of the second end, a third end and a fourth end of the back cover has a curved structure for fixing the tablet, and the third end and the fourth end are substantially perpendicular to the first end.

9. The electronic device of claim 7, wherein each of a third end and a fourth end of the back cover has a curved structure for fixing the tablet, and the third end and the fourth end are substantially perpendicular to the first end.

10. The electronic device of claim 8, wherein the hook is rotated or shifted for fixing the tablet.

11. The electronic device of claim 9, wherein the hook is rotated or shifted for fixing the tablet.

12. The electronic device of claim 7, wherein the back cover is made of metal or plastic material.
